(19) United States
(12) Patent Application Publication
(10) Pub. No.: US 2014/0123578 A1
(43) Pub. Date: May 8, 2014

(54) THERMAL MANAGEMENT OF TRANSPARENT MEDIA

(71) Applicants: Donald E. Ingber, Boston, MA (US); Benjamin D. Hatton, Toronto (CA); Ian R. Wheeldon, Arlington, MA (US); Joanna Aizenberg, Boston, MA (US)

(72) Inventors: Donald E. Ingber, Boston, MA (US); Benjamin D. Hatton, Toronto (CA); Ian R. Wheeldon, Arlington, MA (US); Joanna Aizenberg, Boston, MA (US)

(73) Assignee: PRESIDENT AND FELLOWS OF HARVARD COLLEGE, Cambridge, MA (US)

(21) Appl. No.: 14/000,999

(22) PCT Filed: Mar. 1, 2012
(86) PCT No.: PCT/US2012/027253

§ 371 Date: Jan. 13, 2014

Related U.S. Application Data
(60) Provisional application No. 61/447,872, filed on Mar. 1, 2011.

(51) Int. Cl. E06B 3/67; E06B 3/663

(52) U.S. Cl. CPC E06B 3/6715; E06B 3/6722; E06B 3/66323; E06B 3/66333
USPC 52/171.3; 52/209; 52/173.1

(57) ABSTRACT

A bio-inspired window can be created by applying one or more heat exchange layers to one or more surfaces of a window of a building, boat, vehicle or any other structure. The heat exchange layer can include an interconnected network or array of channels or microchannels that can be used to flow a fluid over the surface of the window. The fluid can be used to heat or cool the surface of the window panel to control the flow of heat across the window and reduce the heating or cooling energy load of building. The fluid can be heated or cooled using the ambient air in the building. The refractive index of the fluid can be adjusted to change of optical transparency properties of the window. In some embodiments, the window can appear nearly as clear as an ordinary panel of glass. In other embodiments, the window can color, block or scatter the incoming light.

### RELATED APPLICATIONS

This application claims benefit under 35 U.S.C. §119(e) of the U.S. Provisional Application No. 61/447,872, filed Mar. 1, 2011, the content of which is incorporated herein by reference in its entirety.

### FIELD OF THE INVENTION

The present invention is directed to using fluidic and microfluidic structures incorporated in the panes of windows for optical and thermal conditioning.

### BACKGROUND OF THE INVENTION

Buildings transfer a significant amount of thermal energy through windows, in the summer (heat gain) or winter (heat loss). In fact windows often represent the most important feature of buildings to cost energy due to this thermal loss or gain. Yet windows are obviously a necessary feature of architecture, and in fact, increasing amounts of glass seem to be used in many modern designs.

Low-emissivity (low-e) glass is designed to include a metal oxide layer that reflects or absorbs light in the IR range, but allows transmission of the visible. This development in the 1970s has increased the energy efficiency of buildings significantly. Such windows are designed to reflect IR back into the room in the winter, and reflect IR from entering the building in the summer. However, in hot climates (and summer months of extreme northern and southern climates) thermal heating of the window itself is still an issue, which contributes to thermal conduction through the window to the room.

### SUMMARY OF THE INVENTION

This invention involves the application of fundamental design principles that living organisms use to control heat exchange as a novel way to minimize heat exchange across the window surfaces of habitable structures (e.g., buildings), boats, vehicles, tents, or any other structure. The invention involves the application of one or more microfluidic heat exchanger layers applied to a surface of a window or window pane. Each heat exchange layer can include a plurality of fluidic or microfluidic channels extending over the surface of the window. In some embodiments of the invention, the channels can be arranged in a patterned network of channels and resemble a capillary network. Each heat exchange layer can include at least one inlet port and at least one outlet port to enable a fluid to flow into the heat exchange layer and out the outlet port. The fluid can include any flowable medium, including solid particles, liquids and gases as well as combinations of any of the materials. Examples of the fluid can include, water, oil and air, as well as suspensions of materials and particles in water or air. In some embodiments of the invention, the heat exchange layer can be transparent to visible light and can block undesirable wavelengths of the electromagnetic spectrum including all or portions of the ultraviolet and infrared spectrum.

While the invention is generally discussed in relation to a building, it is to be understood that invention can used in any structure. For example, the invention can be used for any structure comprising a window. Amenable structures include, but are not limited to, buildings, tents, cars, boats, ships, airplanes, submarines, military vehicles or tanks, and the like. The invention can also be employed to control color, heat, or condensation in lights, cameras, and the like.

In accordance with one embodiment of the invention, the heat exchange layer can be employed in a system for cooling the surface of a window in a building to improve the energy efficiency of the building by feeding the fluid, at a lower temperature than the window, into the heat exchange layer to convectively cool the window and control the transfer of heat energy between the outside and the inside of the building through the window.

In an alternative embodiment of the invention, the system can be used as part of a solar energy harvesting system that supplies heated water to an existing hot water system or to a heat storage system that can be used for warming the building as needed at other times of the day.

In accordance with another embodiment of the building, the heat exchange layer can be employed in a system for heating the surface of a window in a building to improve energy efficiency of the building by feeding the fluid, at a higher temperature than the window, into the heat exchange layer to convectively warm the window and control the transfer of heat energy between the inside and the outside of the building through the window.

In accordance with other embodiments of the system, the fluid that flows through the heat exchange layer can include colored dyes or other materials that change the light transmission properties of the fluid to modulate the light energy that is transferred into a room and further improve energy efficiency, as well as esthetic value. In some embodiments of the invention, different fluids can be selectively fed into the heat exchange layer to modulate light and heat transfer in response to changes in environmental conditions. For example, bright sunlight can be diffused using, a more opaque or light diffusing or scattering fluid that has high heat absorbing properties to reduce the brightness and lower the temperature in the room.

In some embodiments, the fluid can be fed and pushed through the heat exchange layer using gravity, capillary action or an active pressure source such as a pump or an elevated reservoir. The fluid can be fed in the top of the window and gravity can be used draw the fluid down through the heat exchange layer to one or more outlet ports at the bottom of the window. Alternatively, the fluid can be fed in the bottom of the window and the head pressure or capillary action can be used push the fluid up through the heat exchange layer to one or more outlet ports at the top of the window. In other embodiments, channels can be configured to enable the fluid to flow horizontally from one side to the other.

In some embodiments of the invention, the channels on the inside surface of the window can be convection heated or cooled to room temperature by ambient room air that is heated/cooled by the central heating/air conditioning functions of the building. And the exposed surface area of channels distributed across the outside surface of the window would similar be heated or cooled by external environmental conditions, convection and solar energy. These parallel heat exchange layers at the inner and outer surface layers of the window can be connected by channels with fluids flowing in the opposite direction through a central insulating layer so that heat can be exchanged across their walls and the invention can be used to increase the insulating efficiency of the window. The efficiency is derived from the use of a counter current heat exchanger design that mimics designs utilized for similar thermal stabilization effects in living organisms.

These and other capabilities of the invention, along with the invention itself, will be more fully understood after a review of the following figures, detailed description, and claims

### BRIEF DESCRIPTION OF THE DRAWINGS

FIGS. 1A-1C show diagrams of a window including a heat exchange layer according to one embodiment of the invention.

FIGS. 2A and 2B show diagrams of two similar window design embodiments incorporating a heat exchange layer according the invention.

FIG. 3 shows a set of diagrams demonstrating the cooling of a window design according an embodiment of the invention as shown in FIG. 2A.

FIG. 4 shows graphs demonstrating the cooling performance of the window designs according the embodiments of the invention as shown in FIGS. 2A and 2B.

FIG. 5 shows a graph demonstrating light transmissivity using various fluids in a window design according an embodiment of the invention as shown in FIG. 2A.

FIGS. 6A-6D show a set of diagrams of the flow of a carbon black suspension through a window design according to an embodiment of the invention as shown in FIG. 2A.

FIG. 7 shows a diagrammatic view of a counter current heat exchange system according to one embodiment of the present invention.

FIGS. 8A and 8B show diagrammatic views of a counter current heat exchange system according to one embodiment of the present invention.

FIG. 9 shows a diagrammatic view of a bioinspired microfluidic network pattern for use in a heat exchange layer according to one embodiment of the present invention.

FIG. 10 shows a diagrammatic view of an embodiment of a close-loop cooling system.

FIGS. 11A-11D show a set of diagrams of sequential flow of dyes through a window design according to an embodiment of the invention as shown in FIG. 2B.

### DETAILED DESCRIPTION OF PREFERRED EMBODIMENTS

The present invention is directed to a system and method for controlling heat exchange and for reducing heat exchange through the windows of buildings and habitable structures. The invention concerns the application of one or more microfluidic heat exchanger layers applied to one or more surfaces of a window or window pane. The heat exchange layers can be applied on the inside surface, the outside surface and the inner (in-between) surface of multi-pane (or multi-layer) windows. Each heat exchange layer can include a plurality of fluidic or microfluidic channels extending over the surface of the window. In some embodiments of the invention, the channels can be arranged in a patterned network of channels and resemble a capillary network. The heat exchange layers can be used to add or remove heat from the surface of the window to which it is applied.

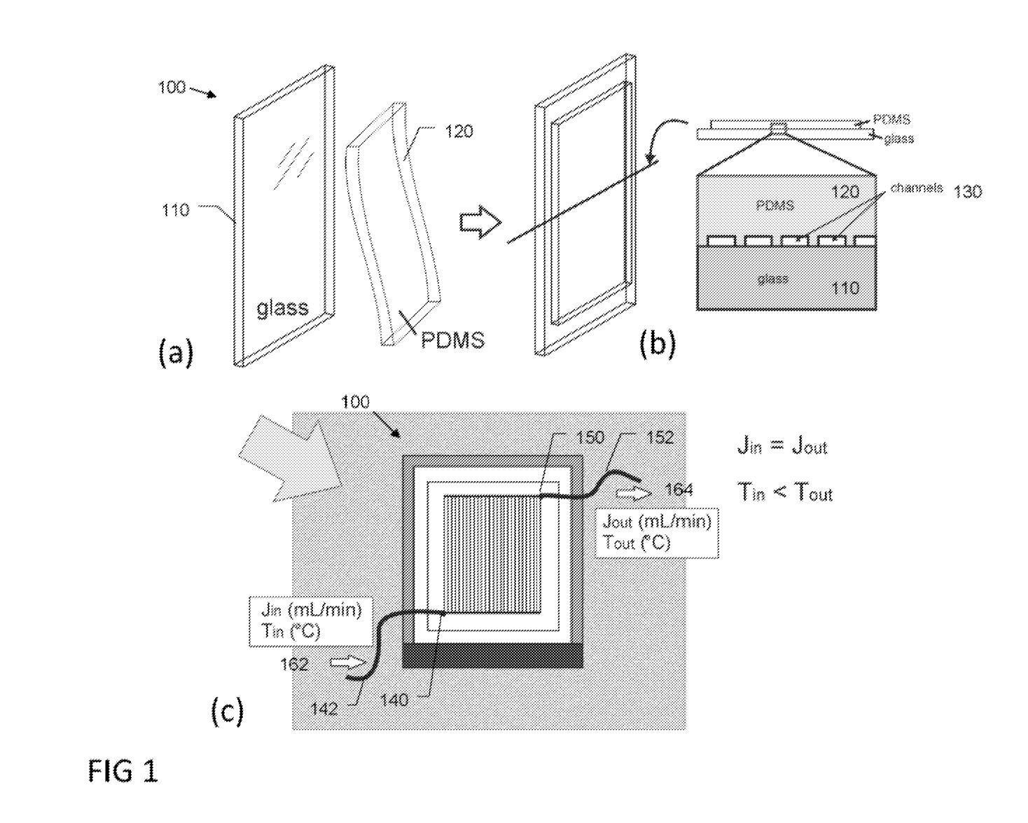

FIG. 1 shows a diagrammatic representation of the fabrication of the transparent component of a window 100 in accordance with one embodiment of the invention. In accordance with this embodiment, a patterned substantially transparent layer 120 of a stiff, rigid or elastomeric material can be laminated to an existing glass window 110. Any material into which a pattern of channels can be applied can be used to produce a window in accordance with the invention, and the selection of the material can be determined based on thermal performance requirements, structural and weight requirements, transparency requirements, and cost (including cost of manufacturing) requirements.

In accordance with one embodiment, as shown in FIG. 1A an elastomeric layer 120, such as polydimethylsiloxane (PDMS) can be fitted to an existing glass window 110. In some embodiments, the elastomeric layer can extend past the edges of the glass to help insulate the window frame as well, which would be valuable in retrofitting applications. The PDMS layer can include one or more patterned arrays of channels 130 that permit the flow of one or more fluids 160 parallel to the plane of the window 110 surface, as shown in FIG. 1B. The contained fluid can flow at a predefined flow rate, J mL/min, such that Jᵢₙ=Jₒᵤₜ, and has an initial temperature of Tᵢₙ and a final temperature of Tₒᵤₜ, as shown in FIG. 1C. Each of the channels 130 can be connected directly or indirectly to one or more inlet ports 140, into which is fed the fluid 162 and each of the channels can be connected directly or indirectly to one or more outlet ports 150 through which the fluid 164 exits the window 110. As disclosed herein, the input fluid 162 can have different properties than the output fluid 164, for example, the fluids can have different temperatures.

In accordance with some embodiments of the invention, more than one set or array of channels can be provided in one or more heat exchange layers adhered to the window 100. In some embodiments of the invention, two or more separate arrays of channels can be provided in a single heat exchange layer to provide heating or cooling or light filtering of a portion of the window, for example, to allow the top and bottom of the window to be treated separately. In some embodiments of the invention, two or more heat exchange layers can be adhered to the window 100, either as layers built up on one side of the window 100 or on both sides of the window 100.

As shown in FIGS. 1A and 1B, the window 100 according to the invention can be constructed by laminating or bonding together a first layer 110 of a transparent material and a second layer 120 of a transparent material. The first layer 110 and second layer 120 transparent materials can be any material used in conventional windows, including for example, glass, crystal, and transparent plastic materials, as well as polydimethylsiloxane (PDMS), polyvinyl chloride, polycarbonate, polyurethane, polysulphonate and equivalent materials. The transparent materials can be selected from many well known materials having known indices of refraction as well as heat transfer and insulating properties in order to best control the direction of heat flow and light transmission.

While the window 100 is described as comprising two layers (110 and 120), it is to be understood that the window can comprise more than two layers. Without limitations, a window can comprise one or more of the first layers 100 and one or more of the second layers 120 arranged in any order desirable. For example, the second layer 120 can be positioned between two first layers 110, i.e. a window comprising three layers in the order 110-120-110. In another example, the second layer 120 can be positioned next to a second layer 120 which is then positioned next to a second first layer 110, i.e. a window comprising four layers in the order 110-120-120-110. In yet still another example, the window can comprise five layers in the order 110-120-110-120-110.

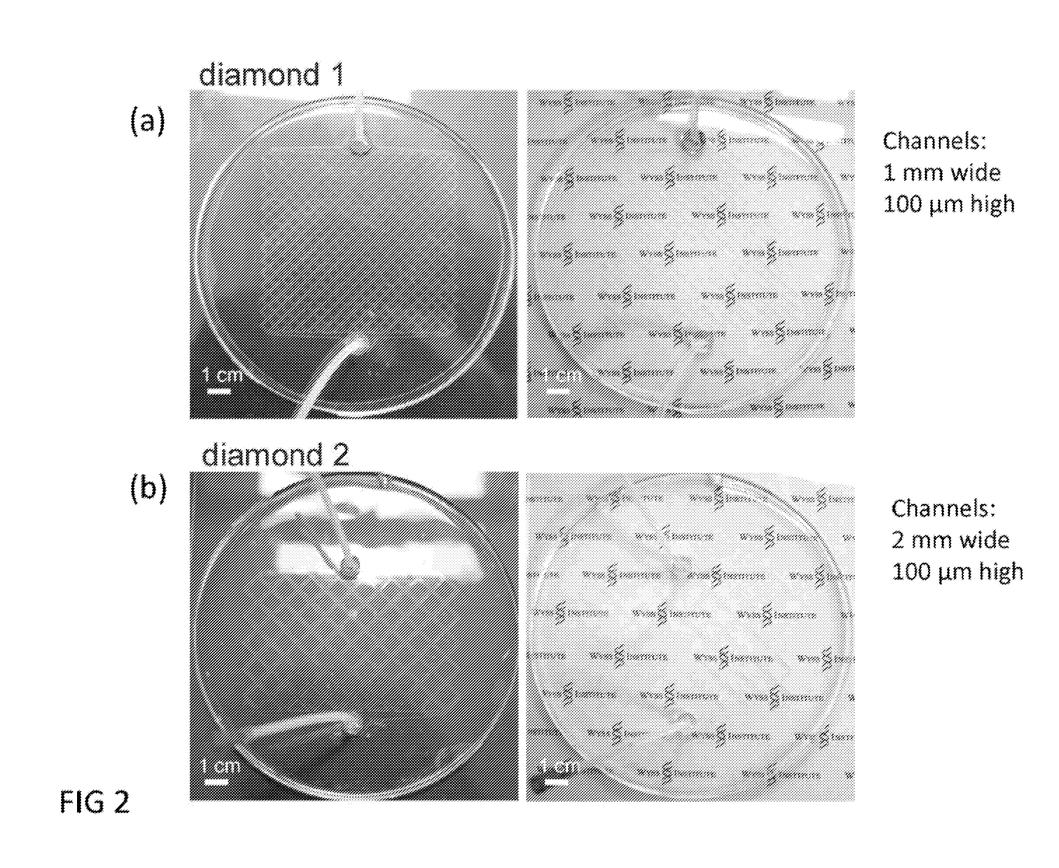

In accordance with some embodiments of the invention, the channels of the heat exchange layer can be etched or otherwise formed (such as by molding or machining) into the surface of the first layer 110 and the etched surface can be covered by the second layer 120 of transparent material. In some embodiments, the second layer 120 can include additional well known and desirable properties, for example, blocking or reflecting all or select portions of the electromagnetic spectrum, for example, ranging from infrared to ultraviolet. In addition, the second layer 120 can also include a pattern that matches or is complementary to the pattern of channels etched into the first layer 110. For example, with regard to the diamond pattern shown in FIGS. 2A and 2B, one set of parallel channels can be etched or otherwise formed into the surface of the first layer 110 and the second set of parallel channels (perpendicular to the first) can be etched or otherwise formed into the surface of the second layer 120.

In accordance with some embodiments of the invention, an additional layer of a material can be positioned between the first layer 110 and the second layer 120 as desired to improve the thermal transfer characteristics of the window. This additional layer of a material can be selected to provide additional thermal insulating or conducting properties to the design of the window to decrease or increase the transfer of energy from the window surface. In one aspect of this embodiment, the second layer 120, including the patterned array of channel, would not be in direct contact with the surface of the first layer 110 of the window. In some aspects of this embodiment, the additional layer of material can include light blocking or reflecting properties, such as the Mylar films used to block or reflect all or select portions of the electromagnetic spectrum, for example ranging from infrared to ultraviolet. In accordance with some embodiments of the invention, the first layer 110 can be bonded or laminated to the second layer to form a transparent window pane using a transparent adhesive, such as a silicone or PDMS based adhesive that provides a conformal seal, or using heat bonding or other adhesives, plastics or polymers.

In accordance with some embodiments of the invention, the second layer 110 can include a patterned array of channels 130 which when bonded to the first layer produce channels and/or microchannels that permit a fluid 160 to flow over predefined areas of the surface of the first layer. As shown in FIG. 1B, the patterned array of channels 130 can be in contact with a substantial portion of the surface of the first layer 110, e.g. the glass layer of the window 100. Alternatively, the channels can be included within the central portion of the first layer 110 and fully surrounded by the material, such as PDMS. In accordance with some embodiments of the invention, the channels 130 can range in width from 0.01 mm to 25 mm and can range in depth from 0.01 mm to 25 mm. The spacing between the channels can range from 0.01 mm to 25 mm. The size and spacing of the channels can be selected according to the desired thermal and optical properties of the window as a person having ordinary skill would appreciate that while increasing the area and/or depth of the channels 130 can increase the thermal transfer capacity of the system, it could also impact the optical transparency and clarity of the window.

In accordance some embodiments of the invention, the channels can be arranged or configured in the form a networked array of channels, for example as show in FIG. 2. In this embodiment, two sets of parallel channels are arranged such that they intersect across the surface of the window. One or more additional sets of parallel channels can be provided and arranged to intersect the two existing sets of parallel channels. In other embodiments, the channels can include non-linear shapes including circular, curved, zig zag or sinusoidal shapes. The channels can be formed in the second layer using well known manufacturing processes including molding, machining, and etching. In other embodiments, the channels can be arranged in predefined geometric, regular or irregular, or fractal based branching patterns. The channels can be arranged and dimensions selected to induce upward fluid flow using capillary action. The dimensions of the channels to induce capillary action can be determined as a function of the properties of the fluid or fluids to be used.

In accordance with the invention, one or more fluids can be caused to flow through the channels of the heat exchange layer. As used herein, the term fluid includes any flowable medium, including solid particles, liquids and gases as well as mixtures or combinations of any of the foregoing materials. Examples include, water and air, as well as suspensions of materials and particles in water or air. Examples of fluids can include water, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, as well as mixtures or combinations of any of the materials disclosed herein. Further examples of fluids can include vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, as well as mixtures or combinations of any of the materials disclosed herein. These and other materials can be selected and used to formulate a fluid that provides a high heat capacity and high heat transfer rate.

In addition, the fluid can include colored dyes or other materials that change the light transmission properties of the fluid to modulate the light energy that penetrates the window. The fluid can have light absorbing, scattering, blocking or reflecting properties that enable the fluid to prevent some or all of the light from being transmitted through the window. In addition, the fluid can be selected or formulated to absorb, scatter, block or reflect a portion of the light transmitted, for example, absorbing, scattering, blocking or reflecting, either partially or entirely, a specific wavelength, range of wavelengths or predetermined portion of the electromagnet spectrum. In some embodiments of the invention, the fluid can include a suspension of nanoparticles including TiO₂, quantum dots, gold, aluminum, nickel, cadmium, antimony, barium, buckminsterfullerenes, carbon, copper, lithium, silica, as well as mixtures or combinations of any of the materials disclosed herein. In some embodiments of the invention, the fluid can include a suspension of particles including carbon black, barium, apatite, beryl, bismuth, calcite, cement, chalk, coal, clay, coke, glass, plastic, stone, mineral, rubber, or organic compounds or polymers, as well as mixtures or combinations of any of the materials disclosed herein. These and other materials can be selected and used to formulate a fluid having the desired index of refraction. In some embodiments, the index of refraction of the fluid can be selected to match that of the first and second layer to maximize optical transparency. In other embodiments, the index of refraction of the fluid can be selected to maximize light diffusion or absorption, either broadly or in one or more narrow bands.

In some embodiments of the invention, the fluid can be fed into the heat exchange layer using gravity, such as by locating the reservoir holding the fluid at an elevation above the level of the window. In some embodiments, the fluid can be fed in the top of the window and gravity can be used draw the fluid down through the heat exchange layer to one or more outlet ports at the bottom of the window. Alternatively, the fluid can be fed in the bottom of the window and the head pressure can be used push the fluid up through the heat exchange layer to one or more outlet ports at the top of the window. In other embodiments, channels of the heat exchange layer can be sized and configured to enable capillary action to draw the fluid through the heat exchange layer, either up from the bottom of the window or across, from one side of the window to the other side of the window. In other embodiments of the invention, a pump can be used to pump the fluid into the window or a pressurized container or up to an elevated reservoir in order to provide the pressure necessary to flow the fluid at the desired flow rate through the channels 130 of the window 100.

In some embodiments of the invention, the flow rate of the fluid through the channels can be in the range from 0.1 mL/min to over 20 mL/min. The flow rate of the fluid can be selected according to the desired heat transfer of the system, taking into account the physical dimensions of the channels and the heat transfer characteristics of the fluid and window materials. In some embodiments of the invention, the Tᵢₙ and Tₒᵤₜ can be monitored and flow rate can be increased or decreased to achieve the desired heat transfer. A computer or microcontroller can be used to receive Tᵢₙ and Tₒᵤₜ data and control a variable speed pump to increase or decrease the flow rate maintain a predefine level of system performance.

In accordance with one embodiment of the invention, where the window is installed in a hot, sunny environment, the fluid flow can be used to convectively cool the inside window surface, absorbing thermal energy from the glass surface, such that Tₒᵤₜ>Tᵢₙ. This convective heat transfer can be used to effectively decrease the temperature of the inner window surface, preventing the heat from entering the building and decrease the energy associated with air conditioning the building. Therefore, this cooling function can be used to increase the insulating efficiency and the overall energy efficiency of the building itself.

In accordance with one embodiment of the invention, the heat exchange layer can be employed in a system for cooling the surface of a window in a building to improve the energy efficiency of the building. The fluid at a lower temperature than the window can be fed into the heat exchange layer to convectively cool the window and control the transfer of heat energy from the outside to the inside of the building through the window. The warmed fluid received from the heat exchange layer can be cooled, either directly or indirectly, by the existing cooling system of the building before being fed back into the heat exchange layer. Alternatively, the warmed fluid can be fed outside where it is allowed to evaporate away.

In an alternative embodiment of the invention, the system can be used as part of a solar energy harvesting system that supplies heated water to the existing hot water system or to heat storage system that can be used for warming the building when the outside temperature drops, such as in the evenings.

In accordance with another embodiment of the building, the heat exchange layer can be employed in a system for heating the surface of a window in a building to improve energy efficiency of the building during the colder seasons. The fluid at a higher temperature than the window can be fed into the heat exchange layer to convectively warm the window and control the transfer of heat energy from the inside to the outside of the building through the window. The cooled fluid received from the heat exchange layer can be re-heated by the existing heating system of the building before being fed back into the heat exchange layer.

In accordance with other embodiments of the invention, the fluid that flows through the heat exchange layer can include colored dyes or other materials that change the light transmission properties of the fluid to modulate the light energy that is transferred into a room and further improve energy efficiency, as well as to provide esthetic control. In this embodiment, different fluids can be selectively fed into the heat exchange layer in response to environmental conditions, for example, by cooperating with the lighting, heating and cooling systems of the building with the goal of providing maximum energy efficiency. A fluid manifold, under thermostatic, electro-optical or computer control can be used to select appropriate solenoid valves to allow the desired fluid to provide more optimum use of energy for the room and the building. For example, where bright sunlight is beaming into a window, a more opaque or light diffusing fluid that has high heat absorbing properties can be selected reduce the brightness in the room and collect the excess heat to control the temperature in the room. The heated fluid can be stored in an insulated container until the sun goes down and then used to warm the window and provide some privacy in the evening hours. Without wishing to be bound by a theory, a steady state thermal transport model can be used to estimate the effect of fluid flow rate on the window temperature.

In some embodiments of the invention, the fluid can be heated or cooled by the ambient air in the room adjacent to the window before the fluid is returned to the channels in the window. For example, during the winter time, the ambient heat in the room adjacent to the window will rise to the ceiling and can be used to warm the fluid in ceiling mounted heat exchange tubing or microfluidic channels. The warmed fluid can be pumped or driven by gravity into the heat exchange layer of the window to warm the window.

In some embodiments of the invention, the heat exchange layer can be provided on one of the surfaces of a multi-pane window. In multi-pane windows, two or more glass panels are provided in a spaced-apart configuration. The space or gap between the glass panels is typically filled with a low energy transferring gas. In some embodiments of the invention, a heat exchange layer can be provided on one or both of the glass panel surfaces in the gap to heat or cool the inside or outside glass panel of the window.

In some embodiments, an outer heat exchange layer can be provided on the outside of the window and an inner heat exchange layer can be provided on the inside of the window. During the cold seasons, solar energy can be used to heat the fluid in the outer heat exchange layer that can flow through the window or window frame and into the inner heat exchange layer and warm the inside of the window. In this embodiment, counter-current flows within an insulating medium separating the panes can be used to enhance heat transfer.

In some embodiments of the invention, the exposed surface area of channels across the inside surface of the window can be convection heated or cooled to room temperature by ambient room air that is heated/cooled by the central heating/air conditioning functions of the house or building. And the exposed surface area of channels distributed across the outside surface of the window would similar be heated or cooled by external environmental conditions, convection and solar energy. These parallel ‘capillary plexuses’ at the inner and outer surface layers of the window can be connected by channels with fluids flowing in opposite direction that are closely juxtaposed to one another so that heat can exchange across their walls. By continuously flowing small volumes of fluids through these channels, the invention can be used to increase the insulating efficiency of the window, sustain the temperature differential across their width, and be maintained at a relatively constant temperature regardless of the temperature differential across the window, thereby minimizing thermal gain in summer and heat loss in winter. The efficiency of this response can be based on incorporation of a counter current heat exchanger design including an insulating layer into the device that mimics configurations that are utilized for similar thermal stabilization effects in living organisms.

FIG. 2 shows examples of channel structures molded in PDMS and bonded to a glass surface. FIG. 2A is labeled Diamond1 and shows a networked array of channels in the form of a diamond pattern. In this embodiment, the channels have a 1 mm×0.10 mm channel cross-section. FIG. 2B is labeled Diamond2 and shows networked array of channels in the form of a diamond pattern. In this embodiment, the channels have a 2 mm×0.10 mm channel cross-section. These PDMS layers can be molded on an original master template, fabricated by cutting a pattern in an adhesive plastic layer by scribe- or laser-cutting and layered on a flat surface. The images on the left side of FIG. 2 show the PDMS layers dry (no fluid in the channels). The images on the right side of FIG. 2 show the channels infiltrated with water, to demonstrate their transparent nature.

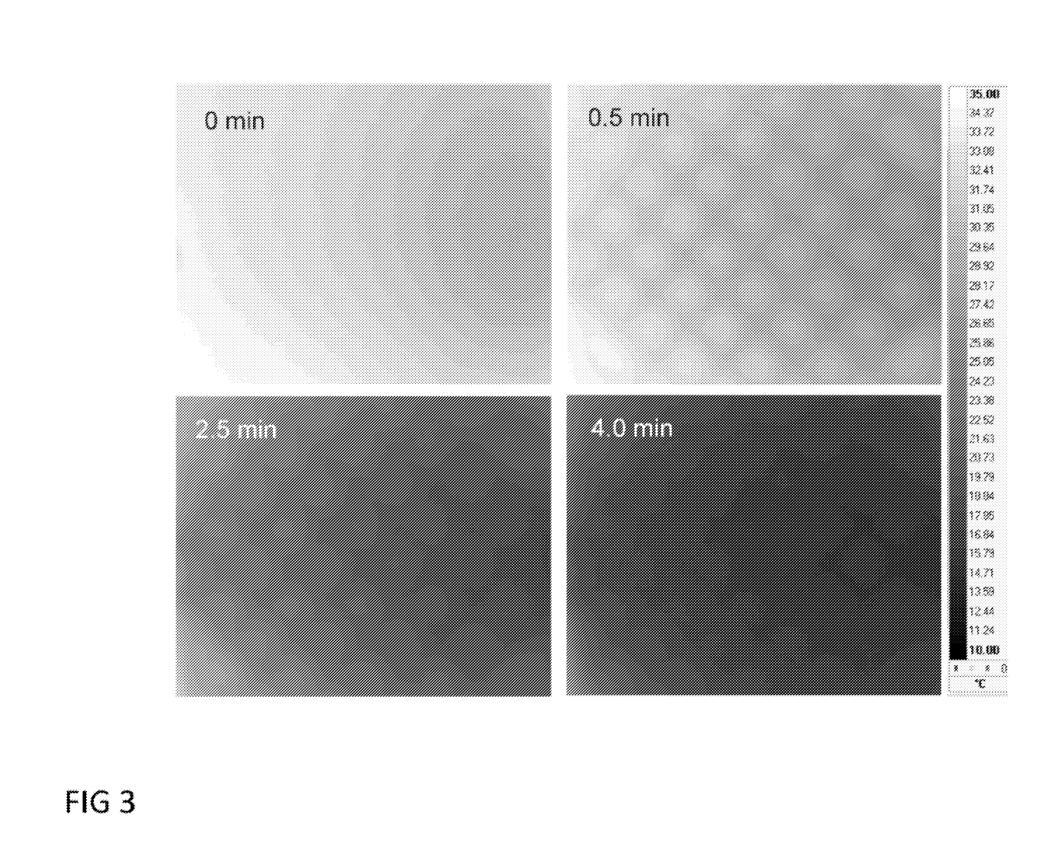

FIG. 3 shows a series of thermal infrared (IR) camera images of the Diamond2 PDMS layer. The layer, bonded to glass to form a window according to one embodiment of the invention, was heated by a nearby light source to an initial temperature around 35° C., without fluid flow. Room temperature water was then pumped through the heat exchange layer at a rate of 2 mL/min, causing the temperature to drop as a function of time. These images show, the darkened color indicating lower temperatures, window at T=0, before cooling; at T=0.5 minutes showing initial cooling in and around the channels and then at T=2.5 and 4.0 minutes, the cooling propagating throughout the area of the layer by heat transfer.

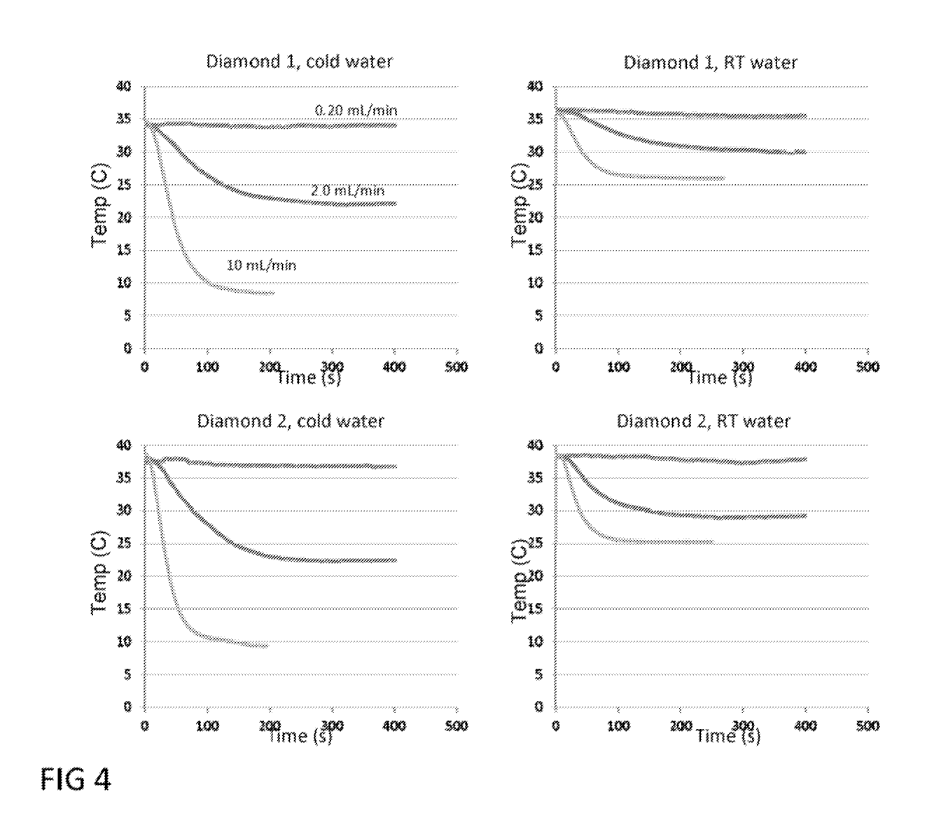

FIG. 4 shows a series of temperature-time graphs for the Diamond1 and Diamond2 layers of FIG. 2 according to one embodiment of the invention, as a function of flow rate (0.2, 2 and 10 mL/min), and for cold (ice water) flow (close to 0° C.) and for room temperature (RT) water flow (close to 20° C.). These results show a significant drop in temperature for both the cold water and room temperature water. The windows started at an initial temperature of between 35 to 38° C. The most dramatic change in temperature was for the cold water at the highest flow rate (10 mL/min), causing a steady state temperature of around 8 to 9° C. for Diamond1 and Diamond2, respectively. The room temperature water caused the temperature to drop to around 25° C. for both windows.

In one embodiment of the invention, using a flow rate of 2.0 mL/min of a fluid at room temperature can be used to cause a temperature drop of around 7 to 10° C. for windows according to the invention. This amount of cooling would be significant for a building in which windows represent a majority of the thermal transfer losses.

In an alternative embodiment, the thermal convective cooling (or heating) of windows can be used to heat water, exiting the windows, as a source of solar heated water for household use.

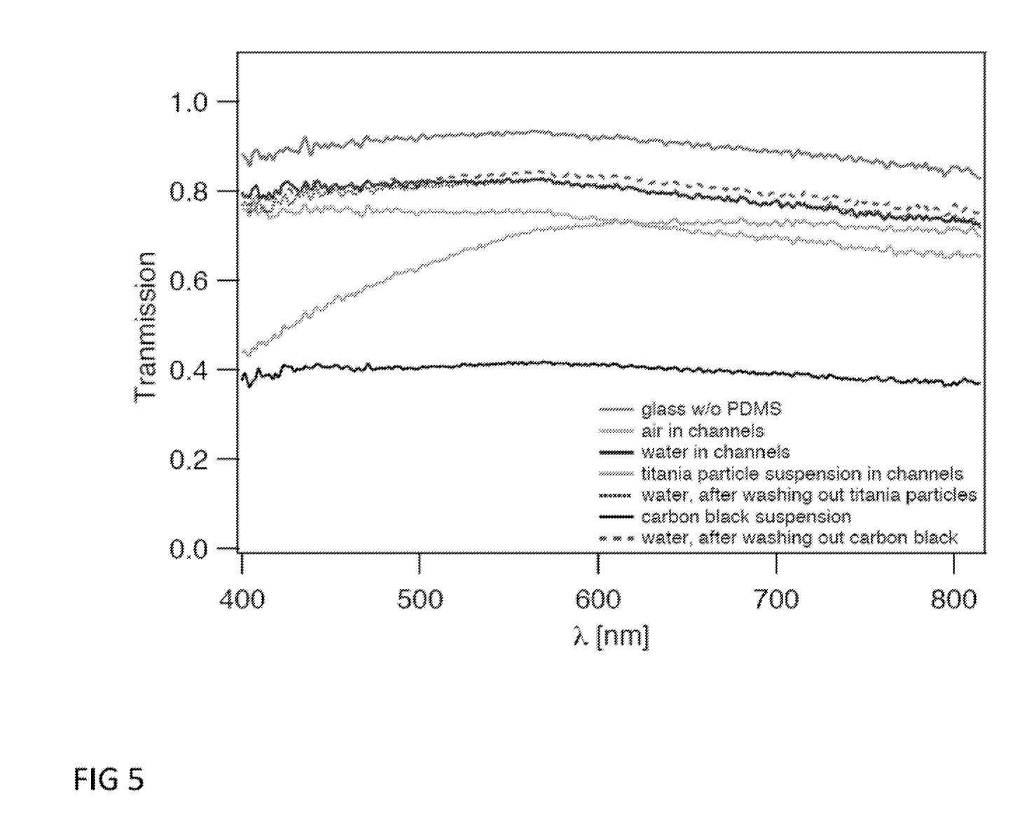

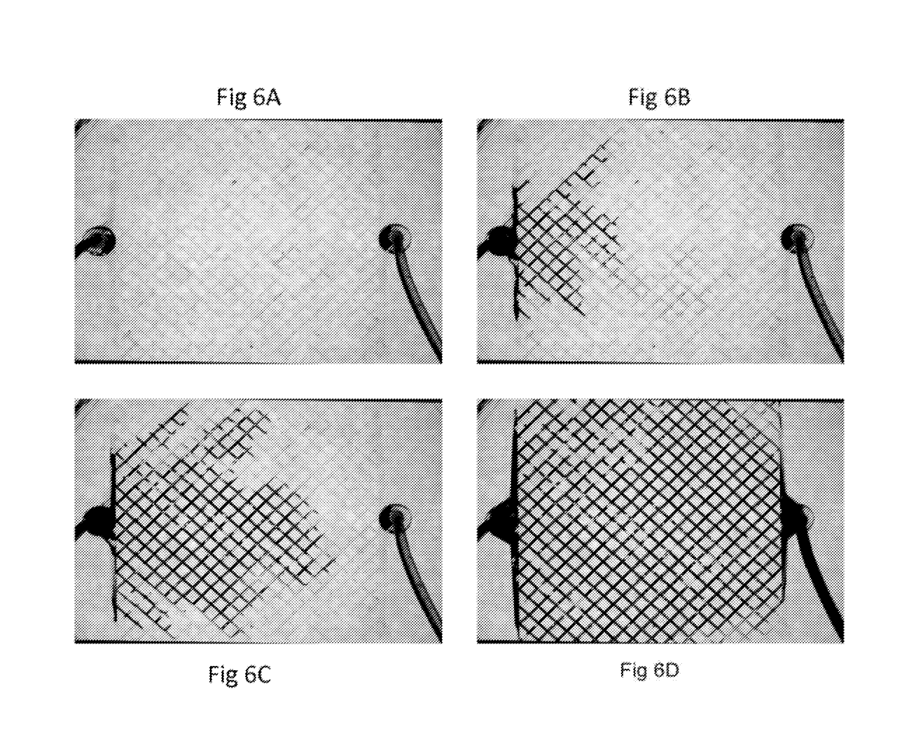

In some embodiments of the invention, an optically-absorbing or cloudy (light scattering) dye or particle suspension could be incorporated into the fluid to actively change the optical absorption/transmission spectrum (i.e.; transparency) of the window as a whole. FIG. 5 shows some optical transmission measurements over a spectral range of 400-800 nm, under different conditions of a network of channels according to the Diamond1 embodiment of the invention. The transmission intensity values are normalized to that for air (representing a value of 1.0). The glass window itself has a transparency value of about 0.9 over this spectral range. With the layer of PDMS (channels empty) it drops to about 0.75 (at 600 nm). When filled with water, it increases slightly to about 0.8 (at 600 nm). When filled with a cloudy suspension of TiO₂ (titania) nanoparticles, which scatter light, the transparency drops to about 0.7 (at 600 nm), but more at lower wavelengths (due to increased scattering at shorter wavelengths). Finally, when filled with a carbon black suspension, as shown in FIG. 6, the transparency drops to about 0.4 across the whole spectral range. When flushed with water, the original transparency values are recovered, demonstrating that the transparency of the window can be actively tuned or adjusted over a range of transparency.

FIG. 6 shows the diamond pattern of FIG. 2A according to an embodiment of the invention in which the channels are filled with carbon black suspension. FIG. 6A shows the window just prior to the flow of the carbon black suspension. FIGS. 6B and 6C show the progression of the flow of the carbon black suspension from the inlet port 140 to the outlet port 150. FIG. 6D shows the patterned array of channels filled with a carbon black suspension.

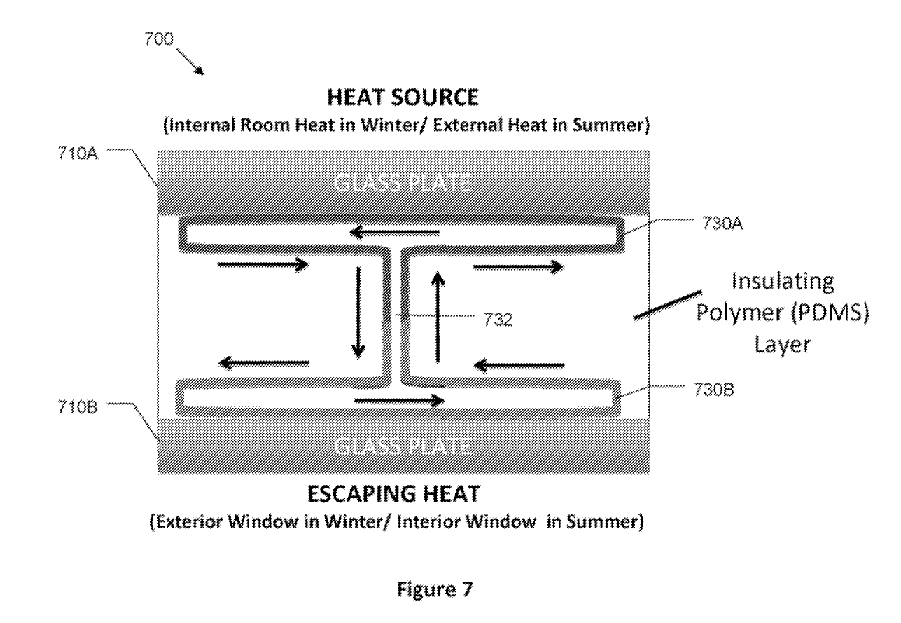

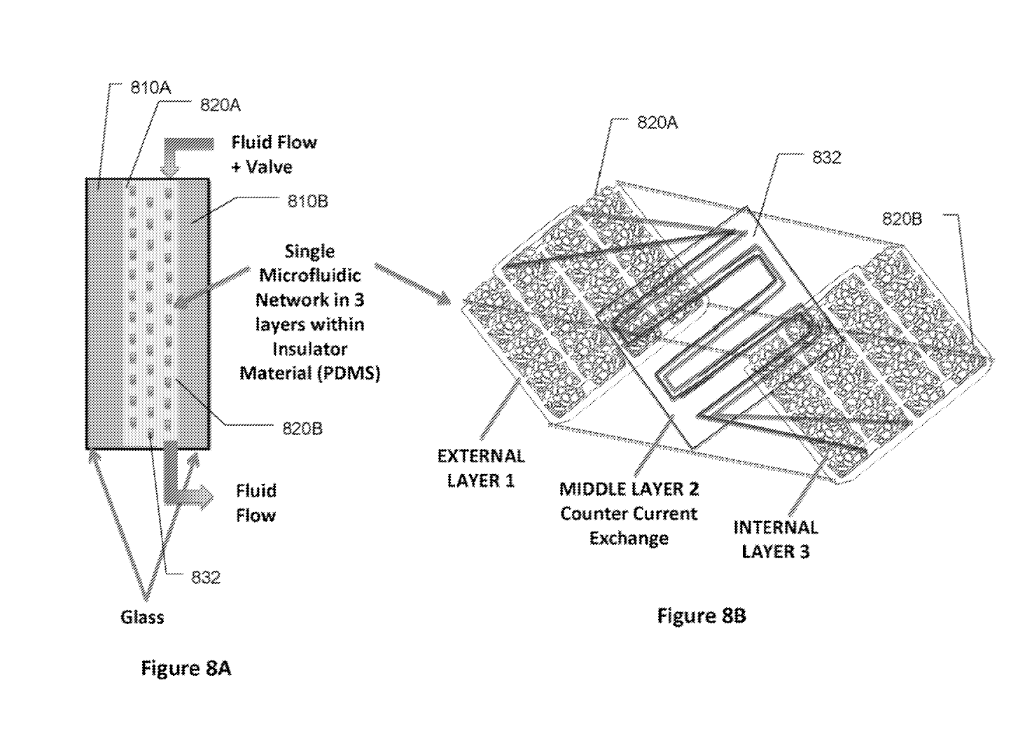

FIGS. 7 and 8 show examples of a counter current heat exchanger system according to one embodiment of the invention. As shown in FIG. 7, two heat exchange layers can be provided in the gap, one on each of the opposing surfaces of the panes of a 2 pane window. Depending on the season, the warm pane will receive heat from the heat source and the cool pane will allow for escaping heat. In this embodiment, heat from the warm pane warms the fluid in the first heat exchange layer and then the fluid flows over a counter current heat exchange path to the second heat exchange layer on the cool pane. The fluid is cooled at the second heat exchange layer and then the fluid flows back through the counter current heat exchange path to the first heat exchange layer. The fluid flowing over the counter current heat exchange path enables the heat lost by the flow in one direction to be gained by the flow in the opposite direction. In this embodiment, the heat exchange layer can be formed within an insulating polymeric material, such as PDMS that mimics the fat layer of animal bodies. Alternatively, the channels can be separated by a vacuum insulator (e.g., with our without filling of Argon gas) and have the opposing flow channels pass through this layer. In this configuration, the inner surface of the window and the insulating material or space can be maintained at a relatively constant temperature through continuous flow of warmed fluid (e.g., water at room temperature due to being exposed on its inner surface to ambient room air heated by the furnace of the building or home). In this embodiment, windows according to the invention can adapt to their environment, whether cold or hot, so as to maintain the temperature at the window surface constant. Maintaining the inner window surface temperature constant should, in turn, greatly reduce heat transfer across between the inside of the room and the exterior, and hence greatly reduce energy usage and costs to the consumer in both winter and summer. An added value of the system is that colored dyes can be flowed through the channel to modulate light energy transfer as well.

In one embodiment of the invention, the window can utilize a closed loop flow system driven by a small electric pump that could be located within the window frame. Alternatively, it could involve use of evaporative pumping and require a water reservoir that requires connection to a continuous source or refilling by the user. The heating can be done by the internal surface of the window that contacts the heated room air in winter, and by the external glass surface that contacts the heated external environment in summer. In both cases, the counter current heat exchanger would minimize heat transfer across the insulated layer. These fluidic channels also could be incorporated in the window frame and window seals to further prevent heat loss along the window edges.

FIG. 8 shows an embodiment of this bioinspired adaptive window according to the invention. In this embodiment, a single connected flow channel is organized into 3 distinct layers with different forms and functions. In the internal and external layers 1 & 3 that are placed in direct contact with the two surface panes of glass, the channel is organized within a highly branched form analogous to that of a capillary plexus to optimize heat transfer across the glass plate, which will heat or cool the fluid flowing in the channel directly beneath its surface. These microcapillary like channels of Layer 1 each then coalesce to form a larger outlet or small number of outlets that connect to simpler tubular channels that crisscross the Middle Layer 2 of the device and pass directly beside similarly shaped and oriented channels that emanate from Layer 3. In this manner, the counter current heat exchange design can be provided within the Middle Layer of the device.

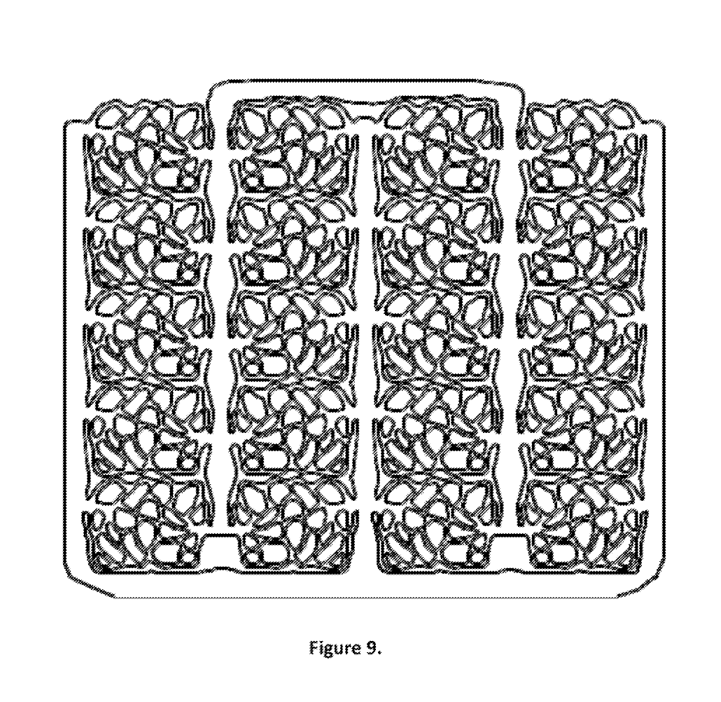

FIG. 9 shows a bioinspired microfluidic network pattern of channels for use in one or more heat exchange layers according to the invention. The network pattern of channels can be composed of an array of unit patterns. In this embodiment, the unit patterns can be the same, however in other embodiments more than one unit pattern can be used to form the network pattern for an area of a window or the entire window. In some embodiments, the unit pattern and/or network pattern can be composed of microfluidic channels as shown in FIG. 9. In other embodiments, the unit pattern and/or the network pattern can be composed of larger “macrofluidic” channels or a combination of microfluidic and macrofluidic channels.

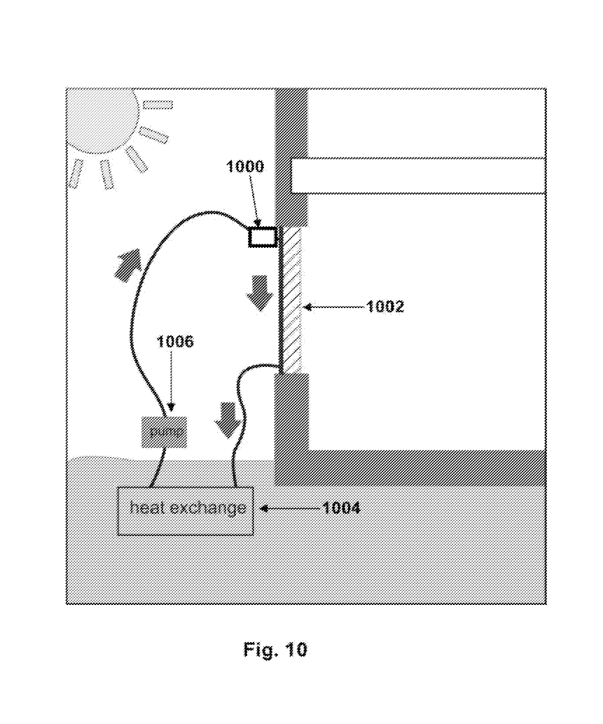

FIG. 10 shows a diagrammatic view of an embodiment of a close-loop cooling system for incorporation into a building. Fluid can be pumped up to a reservoir (1000) and allowed to flow through the channels in the window (1002) due to gravitational flow. This can cool the hot window. The heated fluid can then be cooled in a heat exchanger (1004), to ground temperature. The energy to drive the pump (1006), and maintain the flow in the direction indicated by the arrows, could be solar powered. The reservoir (1000) can be incorporated into the window or can be outside the window.

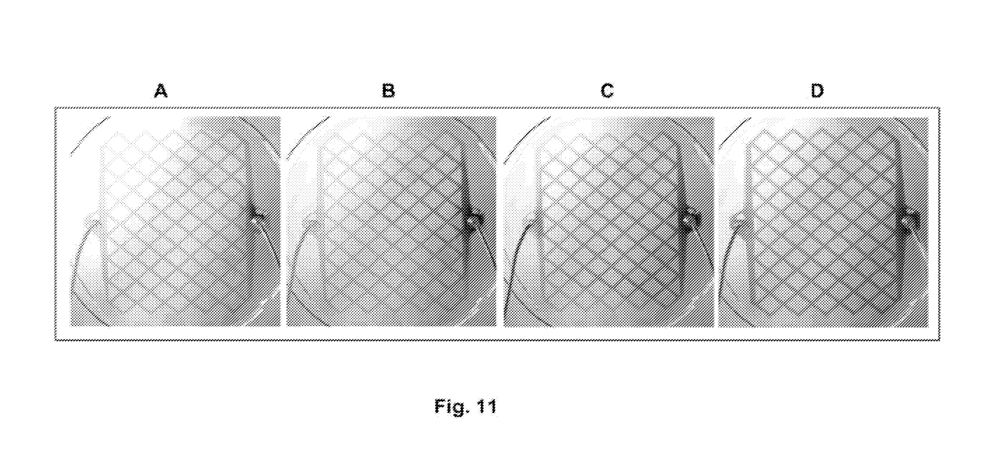

FIG. 11 shows the diamond pattern of FIG. 2B according to an embodiment of the invention in which the channels are filled with dyes. FIGS. 11A-11D show the progression of the sequential flow of different dyes from the inlet port 140 to the outlet port 150. As the dyes fill the channels, color of the channels changes.

Additional descriptions of the principles of the invention and further embodiments of the invention are described in the attached Appendix A, which is hereby incorporated by reference in its entirety.

In accordance with the invention, standard principles for thermal heat exchangers can be applied to this kind of transparent window heat exchange design. For example, the design of the channel network can be made such that the path length of flow is equal across the area of the network. Therefore, there would be uniform heat transfer across the area of the PDMS layer.

Furthermore, in accordance with another embodiment of the invention, ‘smart’ switching of the channels could allow for variable flow of the fluid within the fluidic network, similar to the vascular network of blood flow or in plant leaves. Manual or temperature-sensitive valves could be incorporated to increase flow to increased numbers of channels covering greater surface area on the outside of the window at night to cool buildings in summer or on the inside of the windows to warm windows in winter.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations. Controllers, pumps and valves also can be located within the material surface layer, within a surrounding window frame or at a distance if linked by fluid-bearing channels.

The invention can be described by any of the following numbered paragraphs:
1. A transparent medium forming a window comprising:
   (i) a first transparent layer bonded to a second transparent layer, the second transparent layer including a plurality of channels defining spaces between the first transparent layer and the second transparent layer or within one layer to allow a fluid to flow through the spaces defined by the channels;
   (ii) a first inlet port connected to at least one of the plurality of channels to allow a fluid input to the first inlet port to flow into the at least one channel; and
   (iii) a first outlet port connected to at least one of the plurality of channels to allow a fluid from the at least one channel to flow out through the outlet port.
2. The transparent medium according to paragraph 1, wherein the first transparent layer is formed from a material in the group comprising glass, crystal, transparent plastic, polydimethylsiloxane, polyvinyl chloride, polycarbonate, polyurethane, or polysulphonate.
3. The transparent medium according to paragraph 1 or 2, wherein the second transparent layer is formed from a material in the group comprising glass, crystal, transparent plastic, polydimethylsiloxane, polyvinyl chloride, polycarbonate, polyurethane, or polysulphonate.
4. The transparent medium according to any of paragraphs 1-3, wherein the plurality of channels form a network of intersecting channels.
5. The transparent medium according to any of paragraphs 1-4, wherein the plurality of channels form a capillary network.
6. The transparent medium according to any of paragraphs 1-5, wherein the plurality of channels form a thin film capillary network.
7. The transparent medium according to any of paragraphs 1-6, wherein the channels are between 0.01 mm and 25.0 mm wide.
8. The transparent medium according to any of paragraphs 1-7, wherein the channels are between 0.01 mm and 25.0 mm deep.
9. The transparent medium according to any of paragraphs 1-8, wherein the plurality of channels include a fluid flowing through the channels and provide convective cooling of the first transparent layer or the second transparent layer.
10. The transparent medium according to any of paragraphs 1-9, wherein the plurality of channels include a fluid flowing through the channels and provide convective heating of the first transparent layer or the second transparent layer.
11. The transparent medium according to any of paragraphs 1-10, wherein the plurality of channels include a fluid selected from the group including water, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, or a mixture of any of the foregoing fluids.
12. The transparent medium according to any of paragraphs 1-11, wherein the plurality of channels include a fluid selected from the group of gases or vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or a mixture of any of the foregoing gases.
13. The transparent medium according to any of paragraphs 1-12, wherein the plurality of channels include a fluid comprising a suspension of nanoparticles, wherein the nanoparticles are selected from the group including TiO₂, quantum dots, gold, aluminum, nickel, cadmium, antimony, barium, buckminsterfullerenes, carbon, copper, lithium, silica, or a combination.
14. The transparent medium according to any of paragraphs 1-13, wherein the plurality of channels include a fluid comprising a suspension of particles, wherein the particles are selected from the group including carbon black, barium, apatite, beryl, bismuth, calcite, cement, chalk, coal, clay, coke, glass, plastic, stone, mineral, rubber, organic compounds or polymers, or a combination
15. The transparent medium according to any of paragraphs 1-14, wherein the plurality of channels includes a fluid that is substantially clear.
16. The transparent medium according to any of paragraphs 1-15, wherein the plurality of channels include a fluid that has substantially the same index of refraction as the first transparent layer.
17. The transparent medium according to any of paragraphs 1-16, wherein the plurality of channels include a fluid that has substantially the same index of refraction as the second transparent layer.
18. The transparent medium according to any of paragraphs 1-17, wherein the plurality of channels include a fluid that is less transparent than the first transparent layer and changes opacity of the transparent medium.
19. The transparent medium according to any of paragraphs 1-18, wherein the plurality of channels includes a fluid includes a radiation absorbing dye that changes opacity of the transparent medium.
20. The transparent medium according to any of paragraphs 1-19, wherein the plurality of channels includes a fluid includes a colored dye that changes color of the transparent medium.
21. The transparent medium according to any of paragraphs 1-20, wherein the plurality of channels include a fluid that is less transparent than the first transparent layer and changes the opacity of the transparent medium.
22. The transparent medium according to any of paragraphs 1-21, further comprising at least one fluid source connected to the inlet port and a fluid flowing in the inlet port through at least one channel and out the outlet port.
23. The transparent medium according to any of paragraphs 1-22, further comprising at least one fluid source connected to the inlet port and a fluid flowing in the inlet port through at least one channel and out the outlet port to a heat exchanger that removes heat from the fluid.
24. The transparent medium according to any of paragraphs 1-23, further comprising at least one fluid source connected to the inlet port and a fluid flowing in the inlet port through at least one channel and out the outlet port to a heat exchanger that removes heat from the fluid and the fluid is returned to the fluid source.
25. The transparent medium according to any of paragraphs 1-24, further comprising at least one fluid source connected to the inlet port and a fluid flowing in the inlet port through at least one channel and out the outlet port to a heat exchanger that adds heat to the fluid.
26. The transparent medium according to any of paragraphs 1-25, further comprising at least two fluid sources connected through a manifold to the inlet port and a fluid flowing in the inlet port through at least one channel and out the outlet port; and wherein the manifold includes valves for selectively controlling the flow of at least two fluids through the transparent medium.
27. The transparent medium according to any of paragraphs 1-26, further comprising at least two fluid sources connected through a manifold to the inlet port and a fluid flowing in the inlet port through at least one channel and out the outlet port; and wherein the manifold includes valves for selectively controlling the flow of at least two fluids through the transparent medium and wherein one of the fluids decreases the opacity of the transparent medium and one of the fluids increases the transparency of the transparent medium.

Further, while the description above refers to the invention, the description may include more than one invention.

### Some Selected Definitions

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are useful for the invention, yet open to the inclusion of unspecified elements, whether useful or not.

The singular terms “a,” “an,” and “the” include plural referents unless context clearly indicates otherwise. Similarly, the word “or” is intended to include “and” unless the context clearly indicates otherwise.

Other than in the operating examples, or where otherwise indicated, all numbers expressing quantities of ingredients or reaction conditions used herein should be understood as modified in all instances by the term “about.” The term “about” when used in connection with percentages may mean±5% of the value being referred to. For example, about 100 means from 95 to 105.

Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow. Further, to the extent not already indicated, it will be understood by those of ordinary skill in the art that any one of the various embodiments herein described and illustrated may be further modified to incorporate features shown in any of the other embodiments disclosed herein.

All patents and other publications identified in the specification and examples are expressly incorporated herein by reference for all purposes. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

1. A transparent medium forming a window comprising:
a first transparent layer bonded to a second transparent layer;
the second transparent layer including a plurality of channels defining spaces between the first transparent layer and the second transparent layer or within one layer to allow a fluid to flow through the spaces defined by the channels;
a first inlet port connected to at least one of the plurality of channels to allow a fluid input to the first inlet port to flow into the at least one channel; and
a first outlet port connected to at least one of the plurality of channels to allow a fluid from the at least one channel to flow out through the outlet port.

2. The transparent medium according to claim 1 wherein the first transparent layer is formed from a material in the group comprising glass, crystal, transparent plastic, polydimethylsiloxane, polyvinyl chloride, polycarbonate, polyurethane, or polysulphonate.

3. The transparent medium according to claim 1 wherein the second transparent layer is formed from a material in the group comprising glass, crystal, transparent plastic, polydimethylsiloxane, polyvinyl chloride, polycarbonate, polyurethane, or polysulphonate.

4. The transparent medium according to claim 1 wherein the plurality of channels form a network of intersecting channels.

5. The transparent medium according to claim 1 wherein the plurality of channels form a capillary network.

6. The transparent medium according to claim 1 wherein the plurality of channels form a thin film capillary network.

7. (canceled)

8. (canceled)

9. The transparent medium according to claim 1 wherein the plurality of channels include a fluid flowing through the channels and provide convective cooling of the first transparent layer or the second transparent layer.

10. The transparent medium according to claim 1 wherein the plurality of channels include a fluid flowing through the channels and provide convective heating of the first transparent layer or the second transparent layer.

11. The transparent medium according to claim 1 wherein the plurality of channels include a fluid selected from the group including water, ethylene glycol, oil, silicone oil, hydrocarbons, nitrogen-containing compounds, oxygen-containing compounds, sulfur-containing compounds, fluorinated compounds, carbonyl compounds, alcohols, acids, bases, anhydrides, thiols, esters, heterocyclic compounds, sulfides, organosilicates, organometallic compounds, halogenated derivatives, or a mixture of any of the foregoing fluids.

12. The transparent medium according to claim 1 wherein the plurality of channels include a fluid selected from the group of gases or vapors comprising air, steam, acetone, acetylene, alcohol, ammonia, argon, benzene, butane, carbon dioxide, ethane, ether, ethylene, Freon, helium, hexane, hydrogen, hydrogen chloride, hydrogen sulfide, hydroxyl, methane, methyl chloride, Neon, nitric oxide, nitrogen-containing compounds, oxygen-containing compounds, halogenated compounds, oxygen, nitrogen, pentane, propylene, sulfur dioxide, or a mixture of any of the foregoing gases.

13. The transparent medium according to claim 1 wherein the plurality of channels include a fluid comprising a suspension of nanoparticles, wherein the nanoparticles are selected from the group including TiO₂, quantum dots, gold, aluminum, nickel, cadmium, antimony, barium, buckminsterfullerenes, carbon, copper, lithium, silica, or a combination.

14. The transparent medium according to claim 1 wherein the plurality of channels include a fluid comprising a suspension of particles, wherein the particles are selected from the group including carbon black, barium, apatite, beryl, bismuth, calcite, cement, chalk, coal, clay, coke, glass, plastic, stone, mineral, rubber, organic compounds or polymers, or a combination

15. (canceled)

16. The transparent medium according to claim 1 wherein the plurality of channels include a fluid that has substantially the same index of refraction as the first transparent layer.

17. The transparent medium according to claim 1 wherein the plurality of channels include a fluid that has substantially the same index of refraction as the second transparent layer.

18. (canceled)

19. The transparent medium according to claim 1 wherein the plurality of channels includes a fluid includes a radiation absorbing dye that changes opacity of the transparent medium.

20. The transparent medium according to claim 1 wherein the plurality of channels includes a fluid includes a colored dye that changes color of the transparent medium.

21. (canceled)

22. The transparent medium according to claim 1 further comprising at least one fluid source connected to the inlet port and a fluid flowing in the inlet port through at least one channel and out the outlet port.

23. The transparent medium according to claim 1 further comprising at least one fluid source connected to the inlet port and a fluid flowing in the inlet port through at least one channel and out the outlet port to a heat exchanger that removes heat from the fluid.

24. (canceled)

25. The transparent medium according to claim 1 further comprising at least one fluid source connected to the inlet port and a fluid flowing in the inlet port through at least one channel and out the outlet port to a heat exchanger that adds heat to the fluid.

26. The transparent medium according to claim 1 further comprising at least two fluid sources connected through a manifold to the inlet port and a fluid flowing in the inlet port through at least one channel and out the outlet port; and wherein the manifold includes valves for selectively controlling the flow of at least two fluids through the transparent medium.

27. (canceled)
